(19) United States
(12) Patent Application Publication
(10) Pub. No.: US 2009/0013734 A1
(43) Pub. Date: Jan. 15, 2009

(54) Safety Mechanism for Locks

(75) Inventors: Harald Neumayer, Vienna (AT); Walter Plank, Vienna (AT)

Correspondence Address: CHAPMAN AND CUTLER, 111 WEST MONROE STREET, CHICAGO, IL, 60603, US

(73) Assignees: EVVA-WERK Spezialerzeugung von Zylinder-und Sicherheitsschlossern; Gesellschaft m.b.H. & Co., KG, VIENNA (AT)

(21) Appl. No.: 12/224,200

(22) PCT Filed: Feb. 13, 2007
(86) PCT No.: PCT/AT2007/000073

§ 371 Date: Aug. 20, 2008

(30) Foreign Application Priority Data
Feb. 22, 2006 (AT) A 292/2006

(51) Int. Cl. E05B 13/00

(52) U.S. Cl. 70/218

(57) ABSTRACT

In a security device for locks comprising a grip portion or knob (1) which is freely rotatable in the resting state and can be coupled to the locking member (7) of the lock in the open or closed state, a radially guided displaceable flyweight (13) is coupled to the grip portion or knob (1), which engages with a fixed portion (11) of the lock (12) and blocks any further rotary movement above a defined number of revolutions of the grip portion or knob (1) per unit time.

The invention relates to a security device for locks comprising a grip portion or knob which is freely rotatable in the resting state and can be coupled to the locking member of the lock in the open or closed state.

Conventional locks can be actuated by means of a key, wherein a corresponding locking lug is turned by turning a key in a lock, which shifts a bolt into a locking position or withdraws it from a locking position into an open position. In electronic security systems, instead of the key, an identification logic and an electronic key in the form of cards, key fobs or other identification media are used. After reading the key, which corresponds to the mechanical scanning of a conventional key, the rotary movement of a knob or handle is coupled in a rotationally fixed manner via a corresponding coupling to another rotatably mounted part, which then actuates the bolt. In this connection, electronic security systems have become known which are configured as double-knob cylinders, wherein elements of an identification logic, and in particular antennae or the like are arranged on one side of the door to be opened whereas the coupling of the rotary movement of this external rotatable part after identification of the correct key via an electronic system is mostly carried out electrically by coupling-in a coupling member. In such devices, without such coupling the external knob or handle is freely rotatable. This freely rotatable knob or handle is connected via a shaft to the opposite side of the door or window at which the coupling with the actuating member of the lock is made. The shaft is thereby guided with relatively little play through the lock, wherein the free rotatability must be ensured with relatively little play at the same time without the risk of jamming and without the risk of unintentional coupling. Devices of this type are known, for example as transponder closing systems for cupboards and safe deposit boxes. A possible configuration can be deduced, for example, from DE 19851308 A1 in which the lock cylinder is provided with rotary knobs on both sides, of which the rotary knob on the doors inner side comprises access control electronics. Access authorisation is issued depending on the identity of an identity carrier, whereby a coupling is actuated via an electromagnet in such a manner that a locking bit can be moved from the rotary knob on the outer side of the door.

Due to the small tolerances in the manufacture of such security devices, it has now been shown however that possible abusive tampering can be achieved by connecting a corresponding drive unit, for example, an electric motor or spring mechanism motor, to the freely rotatable grip portion or knob, which sets the grip portion or knob in rapid rotation. During such rapid rotation, corresponding friction heat is generated inside the lock which, during expansion of the usually freely rotating shaft, can result in abrasion or unintentional coupling of an outer shaft to an inner shaft so that in this way, despite the lack of electronic release of the coupling, coupling achieved in a mechanical manner by thermal expansion or abrasion is produced between the usually freely rotatable grip portion or knob and the locking bit, whereby the lock can be actuated. Such accidental operation or sabotage operation however requires that the freely rotatable grip portion of knob can be brought within a minimum time to a corresponding minimum rotational speed which can lead to thermal expansion or abrasion.

It is now the object of the invention to reliably eliminate such sabotage or accidental operation and to ensure that the freely rotatable grip portion or the freely rotatable knob only remains freely rotatable at a relatively low rotational speed and in other cases, counteracts abrasion or jamming.

In order to achieve this object, the inventive security device for locks of the type specified initially substantially consists in that at least one radially guided displaceable flyweight is coupled to the grip portion or knob, which engages with a fixed portion of the lock and blocks any further rotary movement above a defined number of revolutions of the grip portion or knob per unit time. Since a flyweight lock is located in the interior of the lock, it is now ensured that if the rotational speed of the freely rotatable grip portion or knob is too high, a blocking is effected immediately whereby the flyweight engages with a fixed portion of the lock during its radially guided movement and blocks any further rotary movement. As a result of the radial guidance, high blocking forces can be received with small flyweights.

The device is preferably configured such that the flyweight or flyweights can be displaced from a first resting position radially outwards into a second resting position, whereby a precise function is ensured.

According to a preferred further development of the security device according to the invention, the device is configured such that the grip portion or knob is connected to a shaft which dips into the housing of a lock, which has at least one radial opening in which a flyweight is arranged with a centre of gravity located outside the axis of rotation and that a recess or groove is arranged in the housing of the lock into which the flyweight dips during a radial movement of the same. With such a construction, the flyweight is held in an eccentric resting position so that a precisely defined centrifugal force is sufficient to displace it from this resting position into a radially further outwardly located locking position. In this case, the device can be configured in a particularly simple manner such that the flyweight is mounted in an elongated hole of the shaft, wherein the shaft is preferably configured as a hollow shaft and is connected rotationally fixedly to a coupling shaft passing through the lock for coupling with the locking member of the lock. The mounting of the flyweight in the hollow shaft which is itself connected to the coupling shaft at the same time ensures the corresponding eccentric position of the flyweight in the resting position or starting position.

In order to keep the friction losses of the flyweight as low as possible and to ensure a defined starting position, the device is advantageously configured such that the flyweight is held in the elongated hole of the shaft with interposed spring-mounted locking balls.

In both positions of the flyweight, the exact position can be ensured in a particularly simple manner by providing grooves for engagement of the locking balls in a radially inner resting position and a radially outer locking position on the walls of the elongated hole.

A reliable return of the flyweights from their locking position into the resting position can be achieved by the radially displaced flyweights each having bevelled edges in the axial section, by which means the flyweights can be pressed from the radially outer locking position into the radially inner resting position by turning in the direction opposite to the direction of rotation effecting the locking, wherein neighbouring or opposite flyweights in the circumferential direction preferably have sloping surfaces which only effect a release of the blocking with two rotating movements in respectively opposite directions of rotation.

The invention is explained in detail hereinafter with reference to an exemplary embodiment shown schematically in the drawings.

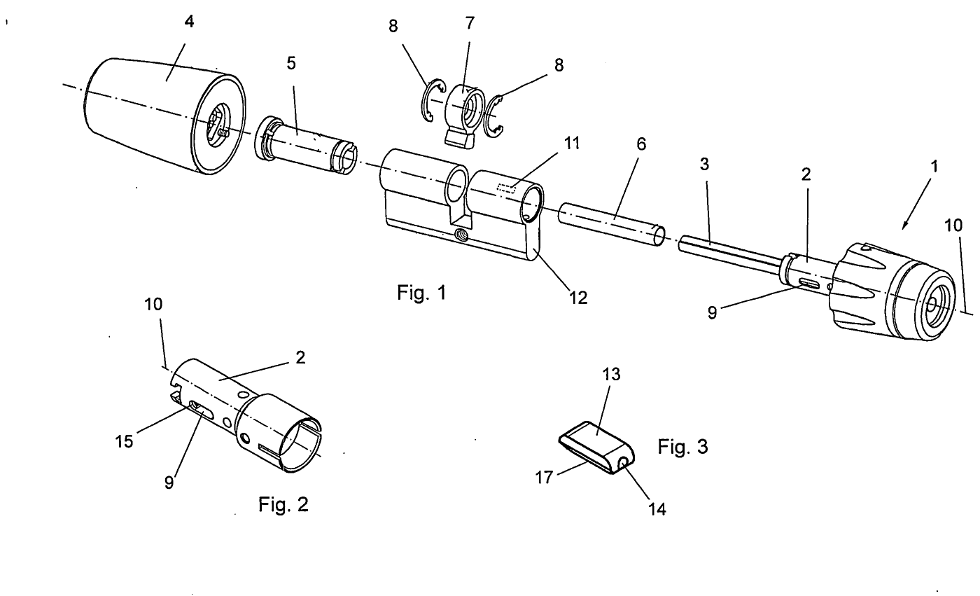

In these FIG. 1 shows a schematic overall view of a lock according to the invention in a partly dismantled state,

FIG. 2 shows an enlarged view of the hollow shaft carrying the flyweight,

FIG. 3 shows an embodiment of such a flyweight and

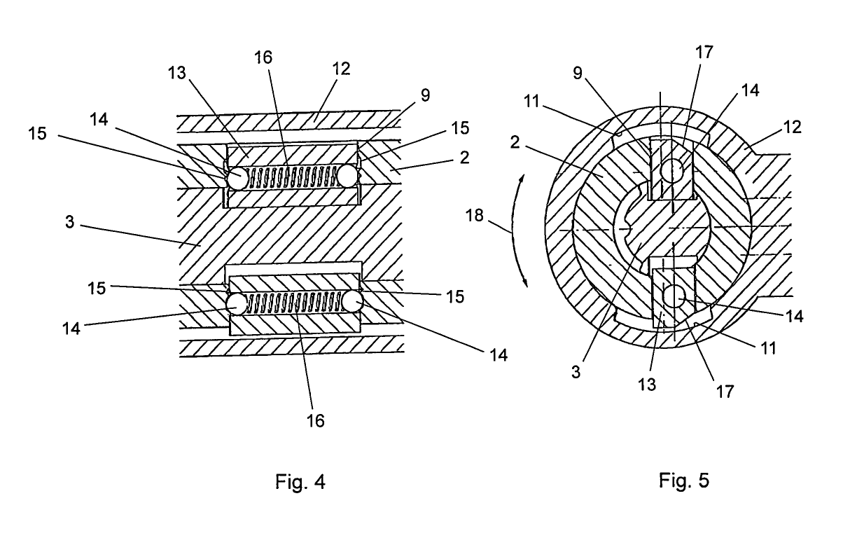

FIGS. 4 and 5 are sectional views through preferred embodiments of the flyweights.

In FIG. 1 reference numeral 1 designates a knob which is connected freely rotatably via a hollow shaft 2 and a coupling shaft 3 to an electromechanical coupling disk accommodated in another knob 4. The coupling disk itself can be configured in an arbitrary manner and can, for example, be coupled magnetically or mechanically to a corresponding component, for example, the knob 4. The actuating shaft is designated by 5 and has a sliding sleeve 6 passing through it. A locking lug 7 is further provided for actuating the lock bolt, wherein this locking lug 7 can be held aligned in the axial direction by corresponding snap rings 8 and is connected rotationally fixedly to the actuating shaft 5 which itself is again connected rotationally fixedly to the inner knob 4 or after coupling has been made, rotationally fixedly to the coupling shaft 3.

Without any corresponding coupling of the actuating shaft 5 to the knob 1, the hollow shaft 2 and the coupling shaft 3 connected thereto can be freely turned. The hollow shaft 2 now has an elongated hole 9 in which a flyweight is inserted, which, during a rapid turning of the knob 1 about the axis of rotation 10, is brought into a radially outward position and in this position can enter into engagement with a groove 11 in the interior of the lock housing 12. In this position, further rotary movement of the knob 1 about the axis 10 is blocked.

In the diagram in FIG. 2 the hollow shaft 2 is shown enlarged. A flyweight 13 is inserted in the elongated hole 9 as shown in an enlarged view in FIG. 3. This flyweight 13 bears spring-mounted balls 14 which can engage in groove-like recesses 15 in the interior of the elongated hole 9 to ensure a secured resting position. Rotation of the hollow shaft 2 about the axis 10 at corresponding rotational speed effects a displacement of the flyweight 13 into a radially outward position in which the flyweight 13 can enter into the groove 11 of the lock housing 12 and the blocking is effected.

In the diagram in FIGS. 4 and 5, two flyweights 13 are shown in section and guided in the elongated hole 9. The locking balls are pressed by means of a spring 16 into the groove-like recesses 13 which can be seen in FIG. 4, wherein separate groove-like recesses or grooves 15 are provided for the resting position of the flyweight shown at the top in FIG. 4 and for the radially outwardly displaced locking position as shown at the bottom in FIG. 4.

In the cross-section of the flyweights in FIG. 5, it is possible to see respectively one sloping edge 17 by which means the flyweights 13 can be locked in the radially inner resting position again by pivoting in the direction of the double arrow 18.

1-9. (canceled)

10. A security device for a lock, comprising:
a grip portion or knob which is freely rotatable in a resting state, and is adapted to be coupled to a locking member of the lock in an open state or in a closed state, wherein
at least one radially guided displaceable flyweight (13) is coupled to the grip portion or knob (1), and
said flyweight (13) engages with a fixed portion (11) of the lock, and blocks any further rotary movement above a defined number of revolutions of the grip portion or knob (1) per unit time.

11. The security device according to claim 10, wherein the flyweight (13) can be displaced from a first locking position radially outwards into a second locking position.

12. The security device according to claim 10, wherein
the grip portion or knob (1) is connected to a shaft (2) which dips into a housing of the lock,
said shaft (2) comprises at least one radial opening (9) in which the flyweight (13) is arranged with a center of gravity located outside an axis of rotation (10) of the shaft (2), and
a recess or groove (11) is arranged in the housing (12) of the lock, into which recess or groove (11) the flyweight (13) dips during a radially outward movement of the flyweight (13).

13. The security device according to claim 10, wherein the shaft (2) is configured as a hollow shaft, and said shaft (2) is connected rotationally fixedly to a coupling shaft (3) which passes through the lock for coupling with a locking member (7) of the lock.

14. The security device according to claim 10, wherein the flyweight (13) is mounted in an elongated hole (9) of the shaft.

15. The security device according to claim 14, wherein the flyweight (13) is held in said elongated hole (9) of the shaft (2) by interposed spring-mounted locking balls (14).

16. The security device according to claim 15, wherein the elongated hole (9) comprises walls having grooves (15) shaped to engage the locking balls (14) in a radially inner resting position and in a radially outer locking position.

17. The security device according to claim 11, wherein each of said at least one flyweight (13) has a beveled edge (17) in an axial section of the flyweight (13), said beveled edge (17) being shaped to press the flyweight (13) from the second radially outer locking position into the first resting position by turning in a direction opposite to a direction of rotation effecting locking of the lock.

18. The security device according to claim 17, wherein neighboring or opposite flyweights (13) of said at least one flyweight (13) in a circumferential direction have sloping surfaces (17), said sloping surfaces (17) being shaped to effect a release of the blocking during two rotating movements in respectively opposite directions of rotation.

19. The security device according to claim 11, wherein
the grip portion or knob (1) is connected to a shaft (2) which dips into a housing of the lock,
said shaft (2) comprises at least one radial opening (9) in which the flyweight (13) is arranged with a center of gravity located outside an axis of rotation (10) of the shaft (2), and
a recess or groove (11) is arranged in the housing (12) of the lock, into which recess or groove (11) the flyweight (13) dips during a radially outward movement of the flyweight (13).

20. The security device according to claim 11, wherein the shaft (2) is configured as a hollow shaft, and said shaft (2) is connected rotationally fixedly to a coupling shaft (3) which passes through the lock for coupling with a locking member (7) of the lock.

21. The security device according to claim 13, wherein the shaft (2) is configured as a hollow shaft, and said shaft (2) is connected rotationally fixedly to a coupling shaft (3) which passes through the lock for coupling with a locking member (7) of the lock.

22. The security device according to claim 11, wherein the flyweight (13) is mounted in an elongated hole (9) of the shaft.

23. The security device according to claim 12, wherein the flyweight (13) is mounted in an elongated hole (9) of the shaft.

24. The security device according to claim 13, wherein the flyweight (13) is mounted in an elongated hole (9) of the shaft.

25. The security device according to claim 12, wherein each of said at least one flyweight (13) has a beveled edge (17) in an axial section of the flyweight (13), said beveled edge (17) being shaped to press the flyweight (13) from the second radially outer locking position into the first resting position by turning in a direction opposite to a direction of rotation effecting locking of the lock.

26. The security device according to claim 13, wherein each of said at least one flyweight (13) has a beveled edge (17) in an axial section of the flyweight (13), said beveled edge (17) being shaped to press the flyweight (13) from the second radially outer locking position into the first resting position by turning in a direction opposite to a direction of rotation effecting locking of the lock.

27. The security device according to claim 14, wherein each of said at least one flyweight (13) has a beveled edge (17) in an axial section of the flyweight (13), said beveled edge (17) being shaped to press the flyweight (13) from the second radially outer locking position into the first resting position by turning in a direction opposite to a direction of rotation effecting locking of the lock.

28. The security device according to claim 15, wherein each of said at least one flyweight (13) has a beveled edge (17) in an axial section of the flyweight (13), said beveled edge (17) being shaped to press the flyweight (13) from the second radially outer locking position into the first resting position by turning in a direction opposite to a direction of rotation effecting locking of the lock.

29. A security device for a lock, comprising:
a grip portion or knob which is freely rotatable in a resting state, and is adapted to be coupled to a locking member of the lock in an open state or in a closed state, wherein
at least one radially guided displaceable flyweight (13) is coupled to the grip portion or knob (1),
said flyweight (13) engages with a fixed portion (11) of the lock, and blocks any further rotary movement above a defined number of revolutions of the grip portion or knob (1) per unit time,
the flyweight (13) can be displaced from a first locking position radially outwards into a second locking position,
the grip portion or knob (1) is connected to a shaft (2) which dips into a housing of the lock,
said shaft (2) comprises at least one radial opening (9) in which the flyweight (13) is arranged with a center of gravity located outside an axis of rotation (10) of the shaft (2),
a recess or groove (11) is arranged in the housing (12) of the lock, into which recess or groove (11) the flyweight (13) dips during a radially outward movement of the flyweight (13),
the shaft (2) is configured as a hollow shaft, and said shaft (2) is connected rotationally fixedly to a coupling shaft (3) which passes through the lock for coupling with a locking member (7) of the lock,
the flyweight (13) is mounted in an elongated hole (9) of the shaft,
the flyweight (13) is held in said elongated hole (9) of the shaft (2) by interposed spring-mounted locking balls (14),
the elongated hole (9) comprises walls having grooves (15) shaped to engage the locking balls (14) in a radially inner resting position and in a radially outer locking position,
each of said at least one flyweight (13) has a beveled edge (17) in an axial section of the flyweight (13), said beveled edge (17) being shaped to press the flyweight (13) from the second radially outer locking position into the first resting position by turning in a direction opposite to a direction of rotation effecting locking of the lock, and
neighboring or opposite flyweights (13) of said at least one flyweight (13) in a circumferential direction have sloping surfaces (17), said sloping surfaces (17) being shaped to effect a release of the blocking during two rotating movements in respectively opposite directions of rotation.
